(19) United States
(12) Patent Application Publication
(10) Pub. No.: US 2023/0004161 A1
(43) Pub. Date: Jan. 5, 2023

(54) SYSTEM AND METHOD FOR GROUNDTRUTHING AND REMARKING MAPPED LANDMARK DATA

(71) Applicant: CNH Industrial America LLC, New Holland, PA (US)

(72) Inventor: Brett Carson McClelland, Chicago, IL (US)

(73) Assignee: CNH Industrial America LLC

(21) Appl. No.: 17/366,490

(22) Filed: Jul. 2, 2021

(51) Int. Cl. G05D 1/02; G05D 1/00

(52) U.S. Cl. CPC G05D 1/0214; G05D 1/0088; G05D 1/0274; G05D 2201/0201

(57) ABSTRACT

A control system for an autonomous work vehicle includes a controller configured to obtain map data for an area that the autonomous work vehicle is traversing, wherein the map data includes mapped landmarks. The controller is configured to determine a current position of the autonomous work vehicle in the area based on feedback from at least a first sensor and to determine a distance between a landmark in the area from the autonomous work vehicle based on feedback from at least a second sensor and the current position of the autonomous work vehicle. The controller is configured to determine a difference between the distance and an estimated distance between the autonomous work vehicle and the landmark based on the map data and the current position of the autonomous work vehicle. The controller is configured to determine whether the landmark is accurately mapped in the map data.

### BACKGROUND

The disclosure relates generally to an autonomous work vehicle.

Certain self-driving work vehicles (e.g., autonomous work vehicles, semi-autonomous vehicles, work vehicles with autoguidance systems, etc.) are configured to traverse portions of a field with and/or without operator input. In planning a mission or operation for the work vehicle, a map is utilized that includes mapped data about landmarks (e.g., telephone poles, ditches, trees, etc.) within the area of the mission or operation. The mapped data for the landmarks are initially recorded by a user who drives around and mark these obstacles utilizing Global Navigation Satellite System (GNSS) and/or inertial measurement units (IMU) devices. When operating an autonomous work vehicle it is important to have confidence in the map data. Unfortunately, as time passes, the accuracy of the mapped landmarks on the map degrades (e.g., due to continental drift, global positioning system (GPS) drift, correction inaccuracy, etc.). This poses a problem for autonomous work vehicles as they need to avoid hitting these landmarks, but pass by very closely.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In one embodiment, a control system for an autonomous work vehicle includes at least one controller including a memory and a processor. The at least one controller is configured to obtain map data for an area that the autonomous work vehicle is traversing, wherein the map data includes mapped landmarks. In addition, the at least one controller is configured to determine a current position of the autonomous work vehicle in the area based on feedback from at least a first sensor. Further, the at least one controller is configured to determine a distance between a landmark in the area from the autonomous work vehicle based on feedback from at least a second sensor and the current position of the autonomous work vehicle. Even further, the at least one controller is configured to determine a difference between the distance and an estimated distance between the autonomous work vehicle and the landmark based on the map data and the current position of the autonomous work vehicle. Still further, the at least one controller is configured to determine whether the landmark is accurately mapped in the map data.

In another embodiment, one or more tangible, non-transitory, machine-readable media include instructions configured to cause a processor to obtain map data for an area that an autonomous work vehicle is traversing, wherein the map data includes mapped landmarks. In addition, the instructions are configured to cause the processor to determine a current position of the autonomous work vehicle in the area based on feedback from at least a first sensor. Further, the instructions are configured to cause the processor to determine a distance between a landmark in the area from the autonomous work vehicle based on feedback from at least a second sensor and the current position of the autonomous work vehicle. Even further, the instructions are configured to cause the processor to determine a difference between the distance and an estimated distance between the autonomous work vehicle and the landmark based on the map data and the current position of the autonomous work vehicle. Still further, the instructions are configured to cause the processor to determine whether the landmark is accurately mapped in the map data.

In a further embodiment, a method for groundtruthing and remarking mapped landmark data utilized by an autonomous work vehicle includes obtaining, via a controller, map data for an area that the autonomous work vehicle is traversing, wherein the map data includes mapped landmarks. The method also includes determining, via the controller, a current position of the autonomous work vehicle in the area based on feedback from at least a first sensor. The method further includes determining, via the controller, a distance between a landmark in the area from the autonomous work vehicle based on feedback from at least a second sensor and the current position of the autonomous work vehicle. The method even further includes determining, via the controller, a difference between the distance and an estimated distance between the autonomous work vehicle and the landmark based on the map data and the current position of the autonomous work vehicle. The method still further includes determining, via the controller, whether the landmark is accurately mapped in the map data.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of a vehicle (e.g., autonomous vehicle) operating within an agricultural field;

FIG. 2 is a block diagram of an embodiment of computing systems for the agricultural vehicle of FIG. 1, and for a remote operations system; and

FIG. 3 is a flow diagram of an embodiment of a method for groundtruthing and remarking mapped landmark data utilized by the vehicle in FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is generally directed to autonomous or self-driving work vehicles. As will be explained below, the embodiments below describe systems and methods for groundtruthing and remarking mapped landmark data. In some embodiments, a control system obtains map data for an area (e.g., field) that an autonomous vehicle is traversing, wherein the map data includes mapped landmarks. The control system may utilize different sensors on the autonomous work vehicle to determine a current position of the autonomous work vehicle and to determine a distance between a landmark in the area and the autonomous work vehicle. The control system may compare this distance to an estimated difference between the autonomous work vehicle and the landmark based on both the map data and the current position of the autonomous work vehicle. From this comparison, an accuracy of the map data with regard to the mapped landmark may be determined and, if needed, a corrective action taken. The disclosed embodiments ensures that the autonomous vehicle may safely navigate an area having obstacles.

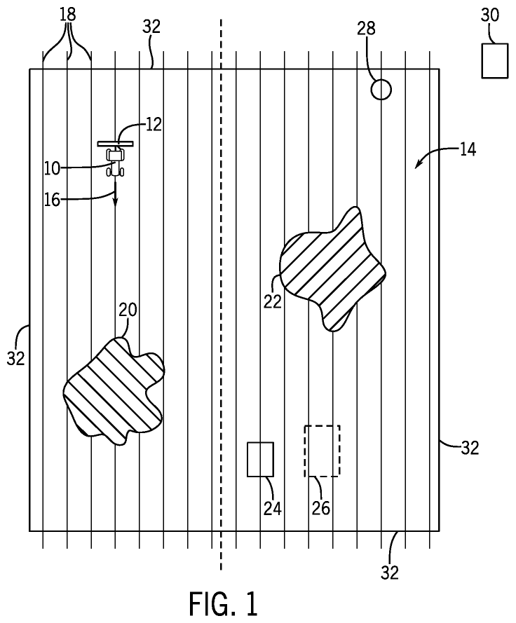

Turning now to FIG. 1, the figure is a schematic diagram of an embodiment of a vehicle 10 (e.g., work vehicle or agricultural vehicle) towing an agricultural implement 12 within an area 14 (e.g., agricultural field). The vehicle 10 may be an autonomous work vehicle, semi-autonomous work vehicle, or work vehicle with autoguidance system. The vehicle 10 may additionally include in-vehicle cab, in which an operator sits during operation of the vehicle 10. In the illustrated embodiment, the work vehicle 12 is configured to operate at least partially autonomously (e.g., without input from an operator present in the cab of the work vehicle 12). An automatic system (e.g., control system) may direct the work vehicle 10 and the agricultural implement 12 throughout the agricultural field 14 without direct control (e.g., steering control, speed control, etc.) by an operator. Further, the vehicle 10 may be remotely operated in addition to or alternative to being driven by an automated system. While in the depicted embodiment, the vehicle 10 is depicted as an agricultural tractor, in other embodiments, the vehicle 10 may be a construction vehicle, a mining vehicle, a passenger vehicle, or the like. The vehicle 10 or other prime mover is configured to tow the agricultural implement 12 throughout the field 14 along a direction of travel 16. In certain embodiments, the vehicle 10 is steered (e.g., via a teleoperator or an automated system) to traverse the field along substantially parallel rows 18. However, it should be appreciated that the vehicle 10 may be steered to traverse the field along other routes (e.g., along a spiral paths, curved paths, obstacle avoidance paths, and so on) in alternative embodiments. As will be appreciated, the agricultural implement 12 may be any suitable implement for performing agricultural operations throughout the field 14. For example, in certain embodiments, the agricultural implement 12 may be a tillage tool, a fertilizer application tool, a seeding or planting tool, or a harvesting tool, among others. While the agricultural implement 12 is towed by the vehicle 10 in the illustrated embodiment, it should be appreciated that in alternative embodiments, the agricultural implement may be integrated within the vehicle 10. In certain embodiments, the vehicle 10 may not include or be coupled to an implement. As described earlier, it should be noted that the techniques describe herein may be used for operations other than agricultural operations. For example, mining operations, construction operations, automotive operations, and so on.

As the vehicle 10 and the agricultural implement 12 traverse the field (e.g., via autonomous operation without operator input), the vehicle 10 and the agricultural implement 12 may encounter various obstacles (e.g., field and/or soil conditions, as well as certain structures). Such field and/or soil conditions and structures may be defined as features for purposes of the description herein. For example, the vehicle 10 and the agricultural implement 12 may encounter features or obstacles such as a pond 20, a tree stand 22, a building, fence, or other standing structure 24 (e.g., telephone pole), transport trailer 26, and miscellaneous features 28, inclines, ditches, muddy soil, and so on. The miscellaneous features 28 may include water pumps, above ground fixed or movable equipment (e.g., irrigation equipment, planting equipment), and so on. In certain embodiments, the tractor 10 includes a mapping system used to operate in the field 14. The mapping system may be communicatively and/or operatively coupled to a remote operations system 30, which may include a mapping server. The remote operations system 30 may be located geographically distant from the vehicle system 10. It is to be noted that in other embodiments the server is disposed in the vehicle system 10. The mapping system enables the vehicle to utilize a map or map data that includes mapped landmark data (i.e., landmarks marked on a map).

In addition to mapping support, in some embodiments the remote operations system 30 may be communicatively coupled to the vehicle 10 to provide for control instructions (e.g., wireless control) suitable for operating on the field 14. The field 14 may include a field boundary 32, as well as the various features, such as the pond 20, the tree stand 22, the building or other standing structure 24, the transport trailer 26, wet areas of the field 14 to be avoided, soft areas of the field to be avoided, the miscellaneous features 28, and so on. As the vehicle 10 operates, the automated system (or remote operator) may steer to follow a desired or planned pattern (e.g., up and down the field) or route based on the map data to avoid obstacles. A control system of the vehicle 10 may utilize sensors to groundtruth and remark mapped landmark data to ensure the vehicle 10 avoids the obstacles.

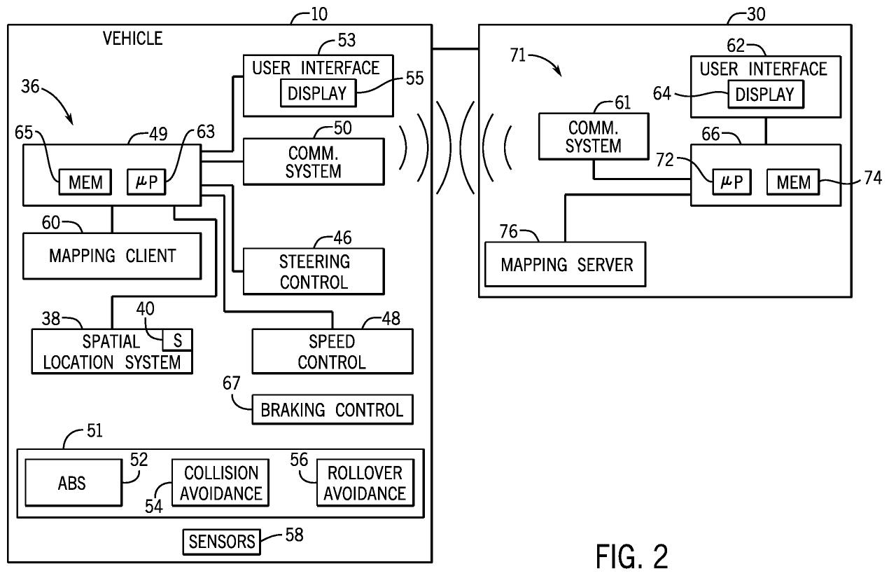

It may be useful to illustrate a system that utilizes groundtruthing and remarking mapped landmark data during operations of the agricultural vehicle 10. Accordingly, and turning now to FIG. 2, the figure is a schematic diagram of an embodiment of a control system 36 that may be employed to control (e.g., autonomously control without operator input) operations of the agricultural vehicle 10 of FIG. 1. In the illustrated embodiment, a control system 36 includes a spatial location system 38, which is mounted to the agricultural vehicle 10 and configured to determine a position, and in certain embodiments a velocity, of the agricultural vehicle 10. As will be appreciated, the spatial location system 38 may include any suitable system including one or more sensors 40 (e.g., receivers or devices) configured to measure and/or determine the position of the autonomous agricultural vehicle 10, such as a global positioning system (GPS) receiver, Global Navigation Satellite System (GNSS) such as GLONASS, and/or other similar system configured to communicate with two or more satellites in orbit (e.g., GPS, GLONASS, Galileo, BeiDou, etc.) to determine the location, heading, speed, etc. of the work vehicle 10 and/or implement 12. The spatial location system 38 may additionally use real time kinematic (RTK) techniques to enhance positioning accuracy. Further, the spatial location system 38 may include inertial measurement units (IMU), which may be used in dead-reckoning processes to validate motion of the GPS position against acceleration measurements. For example, the IMUs may be used for terrain compensation to correct or eliminate motion of the GPS position due to pitch and roll of the work vehicle 10 and/or agricultural implement 12. In certain embodiments, the spatial location system 38 may be configured to determine the position of the work vehicle 10 and the agricultural implement 12 relative to a fixed global coordinate system (e.g., via the GPS) or a fixed local coordinate system.

In the illustrated embodiment, the control system 36 includes a steering control system 46 configured to control a direction of movement of the agricultural vehicle 10, and a speed control system 48 configured to control a speed of the agricultural vehicle 10. In addition, the control system 36 includes a controller 49, which is communicatively coupled to the spatial locating device 38, to the steering control system 46, and to the speed control system 48. The controller 49 is configured to autonomously control the operation of the vehicle 10 as it traverses an area (e.g., field). In certain embodiments, the controller 49 is configured to receive inputs via a communications system 50 to control the agricultural vehicle 10 during certain phases of agricultural operations. The controller 49 may also be operatively coupled to certain vehicle protection systems 51, such as an automatic braking system 52, a collision avoidance system 54, a rollover avoidance system 56, and so on. The vehicle protection systems 51 may be communicatively coupled to one or more sensors 58, such as cameras, radar, stereo vision, distance sensors, lasers (e.g., LADAR), and so on, suitable for detecting objects and distances to objects, and the like. The sensors 58 may also be used by the controller 49 for driving operations, for example, to provide for collision information, and the like.

Also shown is a mapping client system 60 that may provide a map or map data that includes mapped landmark data that may be useful in field operations (e.g., planning and navigating a route through the field that avoids obstacles). The map may be stored in a memory 65 of the controller 49. The recorded map data may be inaccurate due to a variety of reasons (e.g., GPS drift, continental drift, correction inaccuracy, etc.). In certain embodiments, the mapping client system 60 may be communicatively coupled to a user interface system 53 having a display 55 and provide visual maps as well as certain information overlaid and/or adjacent to the maps. The mapping client system 60 may be communicatively coupled to a mapping server system 76. In certain embodiments, the mapping server 76 may provide a map or map data that includes mapped landmark data for the area for use by the mapping client system 66. The map may be one or multiple maps stored in a memory 74 of the mapping client system 66. The mapping server 76 may be disposed in the vehicle 10 as an in-vehicle system. When disposed inside the vehicle 10, the mapping server 76 may be communicatively coupled to the mapping client system 60 via wired conduits and/or via wireless (e.g., WiFi, mesh networks, and so on). In some cases, the mapping server 76 may be used by more than one client (e.g., more than one vehicle, regardless of whether the mapping server 76 is disposed inside of the vehicle or at the remote location 30.

In certain embodiments, the controller 49 is an electronic controller having electrical circuitry configured to process data from the spatial locating device 38, the vehicle protection systems 51, the sensors 58, and/or other components of the control system 36. In the illustrated embodiment, the controller 49 includes a processor, such as the illustrated microprocessor 63, and a memory device 65. The controller 49 may also include one or more storage devices and/or other suitable components. The processor 63 may be used to execute software, such as software for controlling the agricultural vehicle, software for determining vehicle position, identifying obstacles, determining distances of obstacles from the vehicle 10, groundtruthing and remarking mapped landmark data, software to perform steering calibration, and so forth.

Moreover, the processor 63 may include multiple microprocessors, one or more “general-purpose” microprocessors, one or more special-purpose microprocessors, and/or one or more application specific integrated circuits (ASICS), or some combination thereof. For example, the processor 63 may include one or more reduced instruction set (RISC) processors.

The memory device 65 may include a volatile memory, such as random access memory (RAM), and/or a nonvolatile memory, such as read-only memory (ROM). The memory device 65 may store a variety of information and may be used for various purposes. For example, the memory device 65 may store processor-executable instructions (e.g., firmware or software) for the processor 63 to execute, such as instructions for controlling the agricultural vehicle, determining vehicle position, identifying obstacles, determining distances of obstacles from the vehicle 10, groundtruthing and remarking mapped landmark data, and so forth. The storage device(s) (e.g., nonvolatile storage) may include ROM, flash memory, a hard drive, or any other suitable optical, magnetic, or solid-state storage medium, or a combination thereof. The storage device(s) may store data (e.g., position data, vehicle geometry data, maps, etc.), instructions (e.g., software or firmware for controlling the agricultural vehicle, etc.), and any other suitable data.

In certain embodiments, the steering control system 46 may rotate one or more wheels and/or tracks of the agricultural vehicle (e.g., via hydraulic actuators) to steer the agricultural vehicle along a desired route (e.g., as guided by an automated system or a remote operator using the remote operations system 30). By way of example, the wheel angle may be rotated for front wheels/tracks, rear wheels/tracks, and/or intermediate wheels/tracks of the agricultural vehicle, either individually or in groups. A braking control system 67 may independently vary the braking force on each lateral side of the agricultural vehicle to direct the agricultural vehicle along a path. Similarly, torque vectoring may be used differentially apply torque from an engine to wheels and/or tracks on each lateral side of the agricultural vehicle, thereby directing the agricultural vehicle along a path. In further embodiments, the steering control system 46 may include other and/or additional systems to facilitate directing the agricultural vehicle along a path through the field.

In certain embodiments, the speed control system 48 may include an engine output control system, a transmission control system, or a combination thereof. The engine output control system may vary the output of the engine to control the speed of the agricultural vehicle. For example, the engine output control system may vary a throttle setting of the engine, a fuel/air mixture of the engine, a timing of the engine, other suitable engine parameters to control engine output, or a combination thereof. In addition, the transmission control system may adjust gear selection within a transmission to control the speed of the agricultural vehicle. Furthermore, the braking control system may adjust braking force, thereby controlling the speed of the agricultural vehicle. In further embodiments, the speed control system may include other and/or additional systems to facilitate adjusting the speed of the agricultural vehicle.

The systems 46, 48, and/or 67 may be remotely controlled autonomously via the control system 36 or via remote operations, e.g., by using the user interface 62 at a remote location. It is to be noted that remote control may include control from a location geographically distant to the vehicle 10 but may also include control where the human operator may be besides the vehicle 10 and may observe the vehicle 10 locally during operations.

In certain embodiments, the control system 36 may also control operation of the agricultural implement 12 coupled to the agricultural vehicle 10. For example, the control system 36 may include an implement control system/implement controller configured to control a steering angle of the implement 12 (e.g., via an implement steering control system having a wheel angle control system and/or a differential braking system) and/or a speed of the agricultural vehicle/implement system 12 (e.g., via an implement speed control system having a braking control system).

In certain embodiments, the user interface 53 is configured to enable an operator (e.g., inside of the vehicle 10 cab or standing proximate to the agricultural vehicle 10 but outside the cab) to control certain parameter associated with operation of the agricultural vehicle 10. For example, the user interface 53 may include a switch that enables the operator to configure the agricultural vehicle for manual operation. In addition, the user interface 53 may include a battery cut-off switch, an engine ignition switch, a stop button, or a combination thereof, among other controls. In certain embodiments, the user interface 53 includes a display 56 configured to present information to the operator, such as a map with visual representation of certain parameter(s) associated with operation of the agricultural vehicle (e.g., engine power, fuel level, oil pressure, water temperature, etc.), a visual representation of certain parameter(s) associated with operation of an implement coupled to the agricultural vehicle (e.g., seed level, penetration depth of ground engaging tools, orientation(s)/position(s) of certain components of the implement, etc.), or a combination thereof, In certain embodiments, the display 55 may include a touch screen interface that enables the operator to control certain parameters associated with operation of the agricultural vehicle and/or the implement.

In the illustrated embodiment, the control system 36 may include manual controls configured to enable an operator to control the agricultural vehicle while remote control is disengaged. The manual controls may include manual steering control, manual transmission control, manual braking control, or a combination thereof, among other controls. In the illustrated embodiment, the manual controls are communicatively coupled to the controller 49. The controller 49 is configured to disengage automatic control of the agricultural vehicle upon receiving a signal indicative of manual control of the agricultural vehicle. Accordingly, if an operator controls the agricultural vehicle manually, the automatic control terminates, thereby enabling the operator to control the agricultural vehicle.

In the illustrated embodiment, the control system 36 includes the communications system 50 communicatively coupled to the remote operations system 30. In certain embodiments, the communications system 50 is configured to establish a communication link with a corresponding communications system 61 of the remote operations system 30, thereby facilitating communication between the remote operations system 30 and the control system 36 of the autonomous agricultural vehicle. For example, the remote operations system 30 may include a control system 71 having the user interface 62 having a display 64 that enables a remote operator to provide instructions to a controller 66 (e.g., instructions to initiate control of the agricultural vehicle 10, instructions to remotely drive the agricultural vehicle, instructions to direct the agricultural vehicle along a path, instructions to command the steering control 46, braking control 67, and/or speed control 48, instructions to, etc.). For example, joysticks, keyboards, trackballs, and so on, may be used to provide the user interface 62 with inputs used to then derive commands to control or otherwise drive the vehicle 10 remotely.

In the illustrated embodiment, the controller 66 includes a processor, such as the illustrated microprocessor 72, and a memory device 74. The controller 66 may also include one or more storage devices and/or other suitable components. The processor 72 may be used to execute software, such as software for controlling the agricultural vehicle 10 remotely, software for determining vehicle orientation, software for determining vehicle position, identifying obstacles, determining distances of obstacles from the vehicle 10, groundtruthing and remarking mapped landmark data, and so forth. Moreover, the processor 72 may include multiple microprocessors, one or more “general-purpose” microprocessors, one or more special-purpose microprocessors, and/or one or more application specific integrated circuits (ASICS), or some combination thereof. For example, the processor 50 may include one or more reduced instruction set (RISC) processors.

The memory device 74 may include a volatile memory, such as random access memory (RAM), and/or a nonvolatile memory, such as read-only memory (ROM). The memory device 74 may store a variety of information and may be used for various purposes. For example, the memory device 74 may store processor-executable instructions (e.g., firmware or software) for the processor 72 to execute, such as instructions for controlling the agricultural vehicle 10 remotely, instructions for determining vehicle orientation, for determining vehicle position, identifying obstacles, determining distances of obstacles from the vehicle 10, groundtruthing and remarking mapped landmark data and so forth. The storage device(s) (e.g., nonvolatile storage) may include ROM, flash memory, a hard drive, or any other suitable optical, magnetic, or solid-state storage medium, or a combination thereof. The storage device(s) may store data (e.g., position data, vehicle geometry data, etc.), instructions (e.g., software or firmware for controlling the agricultural vehicle, mapping software or firmware, etc.), and any other suitable data.

The communication systems 50, 61 may operate at any suitable frequency range within the electromagnetic spectrum. For example, in certain embodiments, the communication systems 50, 61 may broadcast and receive radio waves within a frequency range of about 1 GHz to about 10 GHz. In addition, the communication systems 50, 61 may utilize any suitable communication protocol, such as a standard protocol (e.g., Wi-Fi, Bluetooth, etc.) or a proprietary protocol.

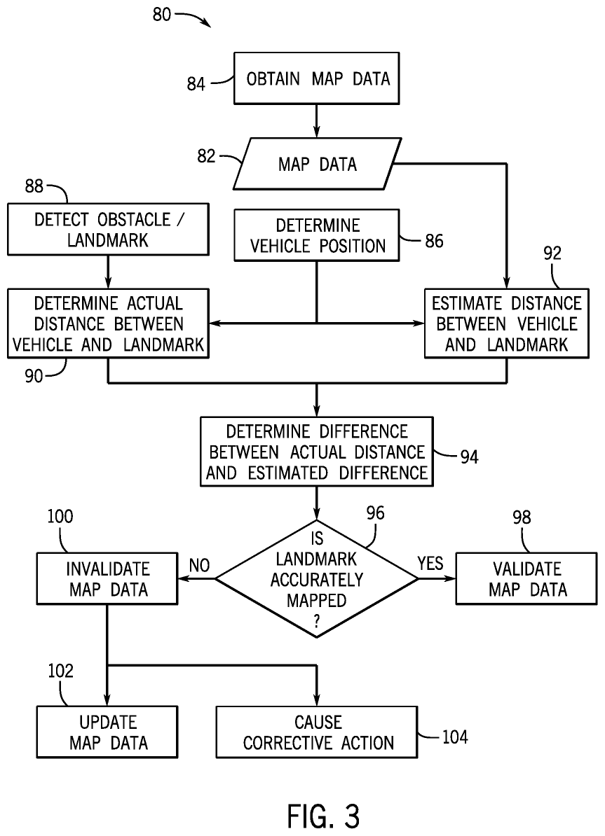

FIG. 3 is a flow diagram of an embodiment of a method 80 for groundtruthing and remarking mapped landmark data utilized by the vehicle 10 (e.g., autonomous vehicle) in FIG. 1. The method 80 may be performed by a component of the control system 36 of the vehicle 10 (e.g., controller 49) utilizing other components of the vehicle 10 (e.g., spatial location system 38, sensors 58, etc.). One or more steps of the method 80 may occur simultaneously or in a different order from that illustrated in FIG. 3. The method 80 includes obtaining a map or map data 82 (block 84). The map data 82 is of an area or field that the vehicle (e.g., autonomous vehicle) is traversing. The map data 82 includes mapped landmarks that were previously recorded. The map data 82 may be stored in and accessed from a memory (e.g., memory 65 in FIG. 2 of the controller 49) on the vehicle. In certain embodiments, the map data 82 may be obtained from a remote operations system (e.g., a memory 74 of the mapping client system 66 in FIG. 2). The method 80 also includes determining a position of the vehicle based on feedback from sensors on the vehicle (e.g., sensors 40 of the spatial location system 38 in FIG. 2) (block 86). The method 80 further includes, as the vehicle traverses the area or field along a preplanned route based on the map data 82, detecting an obstacle or landmark utilizing sensors on the vehicle (e.g., sensors 58 in FIG. 2) (block 88). The detected obstacle or landmark should be a mapped landmark on the map data 82. In certain embodiments, the obstacle or landmark may not be marked in the map data 82 if the obstacle or landmark recently appeared.

The method 80 includes determining a distance (e.g., actual distance) between the detected obstacle or landmark and the vehicle based on the feedback from the sensors that detected the obstacle or landmark (e.g., sensors 58 in FIG. 2) and the current position of the vehicle (e.g., based on the feedback from the sensors 40 of the spatial location system 38 in FIG. 2) (block 90). The method 80 also includes estimating a distance (e.g., estimated distance) between the vehicle and the detected obstacle or landmark based on the mapped location of the obstacle or landmark in the map data 82 and the current position of the vehicle (e.g., based on the feedback from the sensors 40 of the spatial location system 38 in FIG. 2) (block 92). The method 80 further includes determining a difference between the actual distance and the estimated distance between the vehicle and the landmark (block 94).

The method 80 includes determining whether the detected landmark is accurately mapped in the map data 82 (block 96). In certain embodiments, determining whether the detected landmark is accurately mapped includes comparing the difference between the actual distance and the estimated distance to predetermined threshold (e.g., distance threshold). For example, the threshold may be 1, 2, 3 inches or another distance. The threshold may be set to reflect a significant difference that may impact the route of the vehicle. If the difference between the actual distance and the estimated distance is at or less than the threshold, the method 80 includes validating the map data 82 (block 98) and the vehicle can continue along its preplanned route. If the difference between the actual distance and the estimated distance is greater than the threshold, the method 80 includes invalidating the map data 82 (block 100). In certain embodiments, if a certain number of detected obstacles or landmarks (e.g., 2, 3, or more) are inaccurately mapped, the entire map may be invalidated as opposed to just the portion related to a particular mapped landmark or obstacle.

In response to invalidating the map data 82, the method 80 may include updating (e.g., remarking) the map data 82 so that the landmark is accurately mapped (block 102). The updated map data 82, besides being stored on the vehicle, may be communicated to a remote operations system (e.g., a memory 74 of the mapping client system 66 in FIG. 2) so that the map data 82 may be utilized by other vehicles.

In response to invalidating the map data 82, the method 80 may also include causing the vehicle to take a corrective action (block 104). The corrective action may include stopping the vehicle. In certain embodiments, the corrective action may include dynamically changing the route of the vehicle to avoid the landmark and then return to the route as previously planned after avoiding the landmark.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. A control system for an autonomous work vehicle, comprising:
at least one controller comprising a memory and a processor, wherein the at least one controller is configured to:
obtain map data for an area that the autonomous work vehicle is traversing, wherein the map data includes mapped landmarks;
determine a current position of the autonomous work vehicle in the area based on feedback from at least a first sensor;
determine a distance between a landmark in the area from the autonomous work vehicle based on feedback from at least a second sensor and the current position of the autonomous work vehicle;
determine a difference between the distance and an estimated distance between the autonomous work vehicle and the landmark based on the map data and the current position of the autonomous work vehicle; and
determine whether the landmark is accurately mapped in the map data.

2. The control system of claim 1, wherein at least one controller is configured to compare the difference to a predetermined threshold to determine whether the landmark is accurately mapped in the map data.

3. The control system of claim 2, wherein the controller is configured to validate that the landmark is accurately mapped in the map data when the difference is at or less than the threshold.

4. The control system of claim 2, wherein the controller is configured to invalidate the map data for the landmark when the difference is greater than the threshold.

5. The control system of claim 4, wherein the controller is configured to update the map data for the landmark so that that the landmark is accurately mapped in the map data.

6. The control system of claim 1, wherein the controller is configured to cause the autonomous work vehicle to take a corrective action when the landmark is not accurately mapped in the map data.

7. The control system of claim 6, wherein the corrective action comprises stopping the autonomous work vehicle.

8. The control system of claim 6, wherein the corrective action comprises dynamically changing a route of the autonomous work vehicle to avoid the landmark.

9. The control system of claim 8, wherein the correction comprises, upon dynamically changing the route, returning to the route as previously planned after avoiding the landmark.

10. One or more tangible, non-transitory, machine readable media comprising instructions configured to cause a processor to:
obtain map data for an area that an autonomous work vehicle is traversing, wherein the map data includes mapped landmarks;
determine a current position of the autonomous work vehicle in the area based on feedback from at least a first sensor;
determine a distance between a landmark in the area from the autonomous work vehicle based on feedback from at least a second sensor and the current position of the autonomous work vehicle;
determine a difference between the distance and an estimated distance between the autonomous work vehicle and the landmark based on the map data and the current position of the autonomous work vehicle; and
determine whether the landmark is accurately mapped in the map data.

11. The one or more tangible, non-transitory, machine-readable media of claim 10, wherein the instructions are configured to compare the difference to a predetermined threshold to determine whether the landmark is accurately mapped in the map data.

12. The one or more tangible, non-transitory, machine-readable media of claim 11, wherein the instructions are configured to validate that the landmark is accurately mapped in the map data when the difference is at or less than the threshold.

13. The one or more tangible, non-transitory, machine-readable media of claim 11, wherein the instructions are configured to invalidate the map data for the landmark when the difference is greater than the threshold.

14. The one or more tangible, non-transitory, machine-readable media of claim 13, wherein the instructions are configured to update the map data for the landmark so that that the landmark is accurately mapped in the map data.

15. The one or more tangible, non-transitory, machine-readable media of claim 10, wherein the instructions are configured to cause the autonomous work vehicle to take a corrective action when the landmark is not accurately mapped in the map data.

16. The one or more tangible, non-transitory, machine-readable media of claim 15, wherein the corrective action comprises stopping the autonomous work vehicle.

17. The one or more tangible, non-transitory, machine-readable media of claim 15, wherein the corrective action comprises dynamically changing a route of the autonomous work vehicle to avoid the landmark and then returning to the route as previously planned after avoiding the landmark.

18. A method for groundtruthing and remarking mapped landmark data utilized by an autonomous work vehicle, comprising:
obtaining, via a controller, map data for an area that the autonomous work vehicle is traversing, wherein the map data includes mapped landmarks;
determining, via the controller a current position of the autonomous work vehicle in the area based on feedback from at least a first sensor;
determining, via the controller, a distance between a landmark in the area from the autonomous work vehicle based on feedback from at least a second sensor and the current position of the autonomous work vehicle;
determining, via the controller, a difference between the distance and an estimated distance between the autonomous work vehicle and the landmark based on the map data and the current position of the autonomous work vehicle; and
determining, via the controller, whether the landmark is accurately mapped in the map data.

19. The method of claim 18, comprising comparing, via the controller, the difference to a predetermined threshold to determine whether the landmark is accurately mapped in the map data.

20. The method of claim 19, comprising validating, via the controller, that the landmark is accurately mapped in the map data when the difference is at or less than the threshold and invalidating, via the controller, the map data for the landmark when the difference is greater than the threshold.
